(19) United States
(12) Patent Application Publication
(10) Pub. No.: US 2007/0259799 A1
(43) Pub. Date: Nov. 8, 2007

(54) Biodegradable sanitizing portable toilet solution composition with natural freeze-point depressant

(75) Inventors: Brian Kubalik, Virginia Beach, VA (US); Louis A. Isakoff, Virginia Beach, VA (US)

Correspondence Address: GUERRY LEONARD GRUNE, 784 S VILLIER CT., VIRGINIA BEACH, VA, 23452, US

(73) Assignee: Earth Friendly Chemicals, Inc.

(21) Appl. No.: 11/429,498

(22) Filed: May 5, 2006

(51) Int. Cl. C11D 17/00

(52) U.S. Cl. 510/191; 510/192

(57) ABSTRACT

A cleaning and sanitizing biodegradable portable toilet composition that includes a natural freeze-point depressant, salts, olfactory pleasing fragrance(s) and a dark hue colorant is disclosed. The natural freeze-point depressant is primarily a by-product of agricultural processes allowing the composition to remain fluid at lower temperatures for stationary portable toilets and portable toilets in recreational vehicles, aircraft, buses, cruise ships and other forms of mass transmit and the like.

### FIELD OF INVENTION

This invention relates to a cleaning and sanitizing biodegradable portable toilet composition that is a natural freeze-point depressant allowing the composition to remain fluid at lower temperatures.

### BACKGROUND OF INVENTION

It is estimated that there are over 1,400,000 portable toilets worldwide. Each modern portable toilet structure holds about 5 gallons of solution within a 30 gallon holding tank. The holding tanks are generally pumped out when the wastes begin to “pile”, “mound” or become visible through the top surface of the toilet solution or composition.

Most portable toilet solutions consist of water, colorant a deodorizer and possibly a surfactant and cleaner (Walex Products Company, Exodor® PT-50 Portable Toilet Deodorizer). Much of the included prior art relates to indoor toilet cleaning agents, sanitizers, disinfectants and deodorizers in a solid or semisolid form.

Portable toilet compositions must take into consideration temperature variations, effectiveness of covering, pleasant odor, ability to mask strong odors of fecal matter and decomposition of fecal matter, disinfecting, sanitizing, microbial activity suppression and the ability of dyes to remain in suspension over time.

The portable toilet compositions are generally sold as concentrate with the final portable toilet composition comprising about 75% water. The present compositions may include glutaraldehyde, benzalkonium chloride, didocyldimethylammonium chloride, sodium alpha olefin sulfonate, sodium carbonate, sodium chloride, sodium sulfonate sodium didecylbenzene sulfonate, ethanol and/or formaldehyde. Walex® Products Company Inc. in their Exodor® PT-50 Portable Toilet Deodorizer (health rating—2) includes other components that are kept as trade secrets. Inclusion of the previously named components may require special regulatory permitting when the pump truck is emptied at a sewage treatment plant.

Colorants most usually are in dark blue/green hues and are generally selected to coincide with the coloring of the portable toilet structure panel coloring. The preferred colorants are usually darker hues to hide the wastes submerged in the solution. Colorants include FD&C blue #2, marking dyes, coloring agents, bleach stable dyes or pigments as shown in numerous marketing and sales literature.

Deodorizing fragrances are generally concentrates and provide various scents that are pleasing to olfactory senses. Preferably the fragrances have a low odor detection threshold. Suppliers of present portable toilet solutions advertise several fragrances to choose from, such as; Bubble Gum, Cherry, Lemon, Mountain Breeze, Mulberry Twist, Spice and Sunshine (Satellite Industries, Minneapolis, Minn.). Additionally fragrances and deodorizers are primarily comprised of turpenes, limonines, essential oils, alcohols, methyl ethers, ethyl esters, aldehydes, ketones, N-alkyl-N-ethylmorpholinium ethyl sulfate and hydrophylic perfumes.

The following are examples of preferred hydrophylic perfume ingredients: allyl amyl glycolate, allyl caproate, amyl acetate, amyl propionate, anisic aldehyde, anisyl acetate, anisole, benzaldehyde, benzyl acetate, benzyl acetone, benzyl alcohol, benzyl formate, benzyl iso valerate, benzyl propionate, beta gamma hexenol, calone, camphor gum, laevo-carveol, d-carvone, laevo-carvone, cinnamic alcohol, cinnamyl acetate, cinnamic alcohol, cinnamyl formate, cinnamyl propionate, cis-jasmone, cis-3-hexenyl acetate, coumarin, cuminic alcohol, cuminic aldehyde, Cyclal C, cyclogalbanate, dihydroeuginol, dihydro isojasmonate, dimethyl benzyl carbinol, dimethyl benzyl carbinyl acetate, ethyl acetate, ethyl aceto acetate, ethyl amyl ketone, ethyl anthranilate, ethyl benzoate, ethyl butyrate, ethyl cinnamate, ethyl hexyl ketone, ethyl maltol, ethyl-2-methyl butyrate, ethyl methylphenyl glycidate, ethyl phenyl acetate, ethyl salicylate, ethyl vanillin, eucalyptol, eugenol, eugenyl acetate, eugenyl formate, eugenyl methyl ether, fenchyl alcohol, floracetate (tricyclo decenyl acetate), fructone, frutene (tricyclo decenyl propionate), geraniol, geranyl oxyacetaldehyde, heliotropin, hexanol, hexenyl acetate, hexyl acetate, hexyl formate, hinokitiol, hydratropic alcohol, hydroxycitronellol, hydroxycitronellal diethyl acetal, hydroxycitronellol, indole, isoamyl alcohol, iso cyclo citral, isoeugenol, isoeugenyl acetate, isomenthone, isopulegyl acetate, isoquinoline, keone, ligustral, linalool, linalool oxide, linalyl formate, lyral, menthone, methyl acetophenone, methyl amyl ketone, methyl anthranilate, methyl benzoate, methyl benzyl acetate, methyl cinnamate, methyl dihydrojasmonate, methyl eugenol, methyl heptenone, methyl heptine carbonate, methyl heptyl ketone, methyl hexyl ketone, methyl isobutenyl tetrahydropyran, methyl-N-methyl anthranilate, methyl beta naphthyl ketone, methyl phenyl carbinyl acetate, methyl salicylate, nerol, nonalactone, octalactone, octyl alcohol (octanol-2), para-anisic aldehyde, para-cresol, para-cresyl methyl ether, para hydroxy phenyl butanone, para-methoxy acetophenone, para-methyl acetophenone, phenoxy ethanol, phenoxyethyl propionate, phenyl acetaldehyde, phenylacetaldehyde diethyl ether, phenylethyl oxyacetaldehyde, phenyl ethyl acetate, phenyl ethyl alcohol, phenyl ethyl dimethyl carbinol, prenyl acetate, propyl butyrate, pulegone, rose oxide, safrole, terpineol, vanillin, viridine, and mixtures thereof.

Nonlimiting examples of other preferred hydrophilic perfume ingredients which can be used in perfume compositions of this invention are allyl heptoate, amyl benzoate, anethole, benzophenone, carvacrol, citral, citronellol, citronellyl nitrile, cyclohexyl ethyl acetate, cymal, 4-decenal, dihydro isojasmonate, dihydro myrcenol, ethyl methyl phenyl glycidate, fenchyl acetate, florhydral, gamma-nonalactone, geranyl formate, geranyl nitrile, hexenyl isobutyrate, alpha-ionone, isobornyl acetate, isobutyl benzoate, isononyl alcohol, isomenthol, para-isopropyl phenylacetaldehyde, isopulegol, linalyl acetate, 2-methoxy naphthalene, menthyl acetate, methyl chavicol, musk ketone, beta naphthol methyl ether, neral, nonyl aldehyde, phenyl heptanol, phenyl hexanol, terpinyl acetate, Veratrol, yara-yara, and mixtures thereof.

Natural essential oils such as thyme, lemongrass, lemons, oranges, anise, clove, roses, lavender, citronella, eucalyptus, peppermint, camphor, sandalwood and cedar may also be used.

It is found that toilet compositions may additionally contain a surfactant within anionic, non-ionic, cationic, zwitterionic, amphoteric groups and mixtures thereof. Other acceptable surfactants include glycol, etherethoxylates of fatty alcohol (polyoxyethylated C18-C20 alcohols (Rhone Poulenec Inc., Rhodasurf TB 970 FLK), betaines, amphoterics, amine oxides, exothylated amines, block ethylene oxide, propylene oxide, ethylene diamine, nonyl phenol ethylene oxide, alcohol ethoxycarboxylate (NEODOX™ from Shell Chemical; SANDOPAN® from Clariant Corp.), nonoxynol-10 carboxylic acid, alkyl aryl sulfonates, sodium lauryl sulfates, linear alkylbenezene sulfonate isopropylamine salt (Ninate 411), sodium laureth sulfonate (Witcolate™ ES3N), hydroxyethyl olcylimidazoline (Unimine® O), ethyoxylated fatty alcohol carboxylate free acid form (Surfine WNT-A), triethanolamine, dodecylbenzene sulfonate (Calsoft T-60), secondary alkane sulfonate, sodium salt (Hostapur SAS 60), coconut fatty acid-sodium salt (Norfox Coco Powder), sodium cumene sulfonate, quaternary phosphonium and tertiary sulfonium compounds, sodium xylene sulfonate, amine oxides, betaines, amino alkylaryl sulfonate and sulfonates of fatty acids and laurel dimethyl amine oxide.

Toilet compositions may also include a disinfectant such as: aqueous hypohalite, sodium hypochlorite, chloroisocyanurates, haloamines, haloimines, haloimides, haloamides, alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroamines, chlorohydantoins, dichlorodimethylhydantoin and chlorobromo dimethylhydantoin, potassium hypochlorite, magnesium hypochlorite, lithium hypochlorite and calcium hypochlorite, dimethyldodecyclamine oxide, paraffin sulfonates and HCl or H₂SO₄.

Enzymes may be added to aid in decomposition of the wastes when extended storage of wastes in solution is anticipated.

The portable toilet solutions work adequately in temperatures above freezing, but subsequent compositions such as chloride salts may be added to lower the freeze point of the toilet solution. Common additives are magnesium chloride, calcium chloride, sodium chloride and potassium chloride.

Additionally methanol or methyl alcohol may be used as a freeze-point depressant. However, methanol or methyl alcohol, require special handling and precautionary practices due to volatility, storage, transportation and handling issues. Additionally they are also expensive in comparison to salts.

Methanol is highly flammable and must be handled with extreme caution. Addition of methanol to the toilet solution may cause additional costs at the waste treatment plant such as regulatory reporting. Any methanol would have to be readily available and employers would have to comply with governmental regulations regarding storage and handling.

It is therefore highly desirable to have a portable toilet solution that acts as an anti-microbial disinfecting agent, is 100% natural, biodegradable and does not require methanol in order to maintain fluidity in below freezing conditions and is compatible with decomposing enzyme additives.

### DESCRIPTION OF PRIOR ART

U.S. Pat. No. 6,211,128, to Black, Robert, unassigned, describes a shaped, elongated solid toilet bowl cleaning composition, comprising a chelating agent, a surfactant; N-acyl,N,N,N′ ethylene diamine triacetic acid as a dissolution rate reducer and a dissolution rate enhancer in water. The solid toilet bowl cleaning composition is eroded by flushing.

U.S. Pat. No. 4,946,672, to Gibbs, Anthony, and assigned to Walex Products Company, describes an odor removal composition comprising a complexing agent which is a biguanide polymer of the formula in which R, R1, R2 and R3 are a substituted or unsubstituted alkylene group having up to 12 carbon atoms in the unsubstituted chain, HX is an acid, and n has a value of 2 to 20, a carrier capable of assisting wetting of odor forming compositions; and a chemically independent cationic moiety compound chemically associated with a complexing agent or the carrier. This composition is an improved deodorizer and sanitizer as a continuation-in-part of U.S. Pat. No. 4,818,524.

U.S. Pat. No. 4,818,524, to Gibbs, Anthony, and assigned to Walex Products Company, describes an odor removal composition comprising a complexing agent which is a biguamide polymer of the formula in which R, R1, R2 and R3 are a substituted or unsubstituted alkylene group having up to 12 carbon atoms in the unsubstituted chain, HX is an acid, and n has a value of 2 to 20, a carrier capable of assisting wetting of odour forming compositions; and a chemically independent cationic moiety compound chemically associated with a complexing agent or the carrier and an auxiliary complexing agent selected from a transmition metal ion which is capable of oxidation. This composition is a deodorizer and sanitizer with an ammonium salt and an organic acid.

U.S. Pat. No. 6,358,469, to Brun, et. al., and assigned to SC Johnson & Son Inc., describes a deodorizing composition consisting essentially of a clear, aqueous solution of divalent zinc ions in a deodorizing effective amount, and an anionic surfactant in an amount effective to solubilize said divalent zinc ions, such that said solution does not leave a visible residue on a substrate, wherein said anionic surfactant is described by the formula R—(O—CH2—CH2)x—O—CH2 COO—, wherein R is a fatty alcohol substituent or an alkylaryl substituent, the fatty alcohol substituent is a residue of a C6-C20 fatty alcohol, the alkylaryl substituent is a residue of a C10-C20 alkylaryl compound, and wherein X is at least 2.

U.S. Pat. No. 6,660,713, to Carter, et. al., and assigned to Proctor & Gamble Company, describes a composition for controlling malodor on a substrate comprising a hydrophobic nanozeolite having a silica to alumina molar ratio, a compatible carrier and optionally additional ingredients selected from the group consisting of surfactants, perfumes, preservatives, anti-microbials, de-foaming agents, antifoaming agents, bacteriocides, fungicides, antistatic agents, insect and moth repellents, colorants, bluing agents, antioxidants and mixtures thereof.

U.S. Pat. No. 4,202,882, to Schwartz, Herbert, unassigned, describes a method of combating odors comprising contacting the odor causing compounds with a composition consisting essentially of a tetraazaheterocycle selected from the group consisting of hexamethylenetetramine, 1,3,6,8-tetraazatricyclo [4,4,1,13.8]dodecane and 4,5,9,10-dibenzo-1,3,6,8-tetraazatricyclo [4,4,1,13.8]dodecane and a quaternary ammonium salt, the ratio of heterocycle to quaternary ammonium salt being 10:1 to 1:10.

U.S. Pat. No. 6,676,850, to Speronello, et. al., and assigned to Englehard Corp., describes a method of sanitizing and/or deodorizing a solid surface, liquid, or gaseous environment which comprises the steps of exposing a surface or environment to the combination consisting essentially of at least one dry metal chlorite and at least one dry solid deliquescent acidic salt and exposing the combination to an atmosphere containing water vapor to react and produce chlorine dioxide gas.

U.S. Pat. No. 5,403,587, to McCue, et. al., and assigned to Eastman Kodak Co., describes an aqueous antimicrobial composition used for cleaning surfaces comprising an essential oil capable of being dissolved or dispersed in a water carrier, a solubilizing or dispersing agent sufficient to form an aqueous solution or dispersion of an essential oil in a water carrier, solubilizing or dispersing agent, an organic solvent, a surfactant and sufficient water to make 100 weight percent. No salt is added to the formulation.

U.S. Patent Publication No. US20040214736A1, to Modi, Jashawant, unassigned, describes a household product composition comprising a vehicle system which comprises a hydrophobically modified water soluble polysaccharide polymer with a water soluble polysaccharide polymer backbone selected from the group consisting of hydroxyethylcellulose (HEC), hydroxyoropylcellulose (HPC), methylcellulose (MC), hydroxypropylmethylcellulose (HPMC), ethyl hydroxyethylcellulose (EHEC), and methyl hydroxyethylcellulose (MHEC), agar, dextran, locust bean gum, starch, guar, and their nonionic derivatives, and mixtures thereof and a hydrophobic moiety selected from the group consisting of 3-alkoxy-2-hydroxypropyl group wherein the alkyl moiety is a straight or branch chain having 3-24 carbon atoms wherein the hydrophobic moiety is attached to the backbone by an ether linkage and is present in an amount up to the amount which renders the polysaccharide less than 1% by weight soluble in water and at least one active household care ingredient selected from the group consisting of cleaning, sanitizing, polishing, pesticide, fabric softeners, and toilet preparation products, and mixtures thereof.

U.S. Patent Publication No. US20050047961A1, to Bains, et. al., and assigned to Clorox, describes a disinfecting article comprising an aqueous hypohalite releasing composition, an absorbent carrier, and a packaging system dispensibly housing a single or multiple number of disinfectant substrates, wherein the disinfectant article maintains the stability of the hypohalite releasing composition of at least 25% after 11 days at 120° F. This is a toilet bowl cleaning device for hanging inside a tank of an indoor toilet.

U.S. Patent Publication No. US20050025668A1, to Katsigras, et. al., and assigned to Clorox, describes a disinfecting article comprising an aqueous hypohalite releasing composition an absorbent carrier containing an aqueous hypohalite releasing composition wherein the absorbent carrier comprises fibers having a denier of 1.5 or greater. This invention describes a device for allowing water to pass through to a solid or semi-solid toilet bowl cleaner.

U.S. Patent Publication No. US20020127195A1, to Levi, et. al., and assigned to Damar Holdings, SA, describes deodorizing compositions for human and animal excrement comprised of acidic agents and water soluble film forming polymers. The composition is sprayed on excrement and then allowed to solidify thereby capturing the odor and forming odor free solid cakes that are easy for handling.

U.S. Patent Publication No. US20020197287A1, to Streit, et. al., unassigned, describes a composition for reducing malsensory agents while allowing release of a selected component comprising a component selected from the group consisting of fragrances, flavors, and mixtures thereof, undecylenic acid or a derivative thereof in an amount effective to reduce the malsensory agent and allow release of the selected component from the composition and wherein said derivative of undecylenic acid further includes a ratio of methyl ester to ethyl ester.

PCT Patent Publication No. WO9631592A2, to Fukuda, et. al., and assigned to Sanyo Chemical Ind. Ltd., describes a solid toilet deodorizer and cleanser which is a sustained-solubilization agent that is produced from an oxyethylene-containing aromatic compound having a melting point of 50 degrees C. or above together with a water-soluble aliphatic compound. The deodorizer is one produced from the above agent and a microbial material and the cleanser is produced from the above agent, a surfactant and a bleaching agent.

PCT Patent Publication No. WO9621499A1, to Vermeiren, J., and assigned to Biobreak, Inc., describes a composition for treating waste in a septic system comprising a solution of alkyl-diazalheptanic acid, poly-alcohol, alkali metal salt, a boron compound, protease enzyme, a cellulase enzyme and water.

PCT Patent Publication No. WO0139808A1, to Araki, et. al., and assigned to Oshinka Shinko Co. Ltd., describes an aldehyde-deodorizing compositions for efficiently removing aldehydes (acetaldehyde, formaldehyde, etc.) which are bad-smelling components and cause a fear of badly affecting the human health comprising at least one member selected from among hydrazides, azoles and azines and at least one member selected from among metal halides, nitrates, sulfates, sulfites and hydroxides.

### SUMMARY OF THE INVENTION

The present invention relates to a cleaning and sanitizing biodegradable portable toilet composition that provides a natural freeze-point depressant allowing the composition to remain fluid in colder weather.

Preferably the composition comprises steepwater from the wet milling process of corn, a salt, a fragrance, colorant and optionally water.

Most preferably the composition comprises at or about 84 percent magnesium chloride (MgCl₂) and about 16 percent steepwater, olfactory pleasing fragrance and a dark hued colorant.

Another preferred embodiment includes a composition comprising a mixture of 75 percent magnesium chloride (MgCl₂) and about 25 percent steepwater, olfactory pleasing fragrance and a colorant.

Additionally a preferred embodiment includes a mixture of 50 percent magnesium chloride (MgCl₂) and about 50 percent steepwater, olfactory pleasing fragrance and a colorant.

Additionally a preferred embodiment includes a composition diluted at a specific weight, percentage or molar ratio with water the resultant composition comprising at least 5 parts per million (ppm) chlorine concentration.

Another embodiment is a composition comprising calcium chloride (CaCl₂), sodium chloride (NaCl), potassium chloride (KCl), brine, calcium magnesium acetate (CMA), sodium acetate, potassium acetate, sodium hypochlorate or any other salts with a naturally biodegradable freeze-point depressant in combination with an olfactory pleasing fragrance and a colorant.

An additional embodiment would comprise individually or any of the combinations of salt and steepwater in any ratio between 50-84 percent salt and 16-50 percent steepwater.

An additional embodiment would comprise any of the combinations of salt and whey, brewers condensed solubles (BCS), distillers condensed solubles (DCS), vinters condensed solubles (VCS) and/or condensed corn steep liquors (CCSL) in any ratio between 50-84 percent salt and 16-50 percent whey, BCS, DCS, VCS, and/or CCSL.

An additional embodiment includes a composition that would be useful for portable toilets in recreational vehicles, aircraft, buses, cruise ships and other forms of mass transmit and the like.

An additional embodiment includes sustained microbial activity to aid in the decomposition of wastes and that additional enzymes in gel, liquid or powder form may be added.

An additional embodiment is that the composition may be comprised of any agricultural products including waste products such as: steepwater from the wet milling process of corn, Condensed Corn Steep liquors (CCSL), corn syrup, whey, beet molasses, molasses, sugar in the molecular range of 180 to 1638, glycerols, glycols, citric acid, lactic acid, primary alcohols, secondary alcohols, tertiary alcohols, glycolethers, wheat, rice, soy,

An additional embodiment is that the composition may be comprised of any waste concentrate of alcohol distilling and brewing industries such as: brewers condensed solubles (BCS), vinters condensed solubles, corn liquor, malt swill, Distillers Condensed Solubles (DCS).

An additional embodiment is that the composition may be comprised of a sugar water solution, dissolved sugar solid, monosaccharide, maltotriose, dextrose, polymers of dextrose, carbohydrate, glucose, fructose, hydroxycarboxylic acids, hydroxycarboxylic acid esters, glycosides, hydrocarbyl aldoside, acetate salts, formate salts, citrate salts, amino acids, salts of amino acids, dicarboxylic acid salts, lignin compounds, boric acid, salts of boric acid, ethylene glycol, propylene glycol, furanosides, maltosides, maltotriosides, glucopyranosides, sorbitol disaccharides, decasaccharides, polysaccharides, maltodextrins, maltitol, low molecular weight carbohydrate in the molecular weight range of about 180 to 1500, acetates, oligopeptide, molecular weight of molasses from 260 to 295 from cane sugar molasses, sugar beet molasses, citrus molasses, corn sugar molasses or like byproducts of agricultural processes.

Additionally, the use of an insect repellant with any of the compositions presented may be added. An example of insect repellant that may be used includes citronella and other naturally occurring or derived compounds also known to repel insects. In the present invention, flies and mosquitoes are the most prevalent insects and therefore the need exists to repel or eliminate these from the portable toilet area.

Table 1 defines acceptable freeze-point depressant agricultural byproducts.

Table 2 defines acceptable salts to be used in conjunction with the freeze-point depressant agricultural byproducts defined in Table 1.

TABLE 1
Freeze-point Depressants

Steepwater
Condensed corn steep
liquors (CCSL)
Corn Syrup
Whey
Beet Molasses
Molasses
Sugar in the molecular
range of 180 to 1638
Glycerols
Carbohydrate
Citric Acid
Lactic Acid
Primary Alcohols
Secondary Alcohols
Tertiary Alcohols
Glycolethers
Wheat
Rice
Soy
Brewers Condensed
Solubles (BCS)
Vinters Condensed
Sloubles (VCS)
Corn Liquor
Malt Swill
Boric Acid
Ethylene Glycol
Furanosides
Sorbitol Disaccharides
Maltitol
Citrus Molasses
Distillers Condensed Solubles (DCS)
Sugar Water Solution
Dissolved Sugar Solid
Monosaccharide
Maltotriose
Dextrose
Polymers of Dextrose
Glycols
Glucose
Fructose
Hydroxycarboxylic Acids
Hydroxycarboxylic Acid Esters
Glycosides
Hydrocarbyl Aldoside
Amino acids
Lignin Compounds
Propylene Glycol
Maltosides
Glucopyranosides
Decasaccharides
Maltodextrins
Acetates
Sugar Beet Molasses
Corn Sugar Molasses
Maltotriosides
Polysaccharides
Oligopeptide
Low molecular weight carbohydrate in the molecular weight range of about 180 to 1500
Molecular weight of molasses from 260 to 295 from cane sugar molasses

TABLE 2
Available Salts

Magnesium chloride (MgCl₂)
Calcium chloride (CaCl₂)
Potassium chloride (KCl)
Calcium magnesium acetate (CMA)
Acetate salts
Formate salts
Dicarboxylic acid salts
Sodium chloride (NaCl)
Brine
Sodium acetate
Potassium acetate
Citrate salts
Salts of amino acids
Salts of boric acid

A procedure for making a concentrate (or otherwise) solution is shown below:

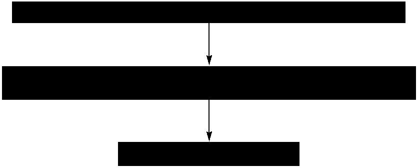

What is claimed is:

1. A biodegradable sanitizing portable toilet solution composition comprising; a freeze-point depressant, a salt, a fragrance, a colorant, and optionally an insect repellant.

2. A biodegradable sanitizing portable toilet solution composition as in claim 1, wherein said freeze-point depressant comprises steepwater, distillers condensed solubles (DCS), condensed corn steep liquors (CCSL), sugar water solution, corn syrup, dissolved sugar solid, whey, monosaccharide, beet molasses, maltotriose, molasses, dextrose, sugar in the molecular range of 180 to 1638, polymers of dextrose, glycerols, glycols, carbohydrate, glucose, citric acid, fructose, lactic acid, hydroxycarboxylic acids, primary alcohols, hydroxycarboxylic acid esters, secondary alcohols, glycosides, tertiary alcohols, hydrocarbyl aldoside, glycolethers, amino acids, wheat, rice, lignin compounds, propylene glycol, soy, maltosides, brewers condensed solubles (BCS), glucopyranosides, vinters condensed solubles (VCS), decasaccharides, corn liquor, maltodextrins, malt swill, acetates, boric acid, sugar beet molasses, ethylene glycol, corn sugar molasses, furanosides, maltotriosides, sorbitol disaccharides, polysaccharides, maltitol, oligopeptide, citrus molasses, low molecular weight carbohydrate in the molecular weight range of about 180 to 1500, molecular weight of molasses from 260 to 295 from cane sugar molasses or like byproducts of agricultural processes.

3. A biodegradable sanitizing portable toilet solution composition as in claim 1, wherein said salt comprises magnesium chloride (MgCl₂), sodium chloride (NaCl), calcium chloride (CaCl₂), brine, potassium chloride (KCl), sodium acetate, calcium magnesium acetate (CMA), potassium acetate, acetate salts, citrate salts, formate salts, salts of amino acids, dicarboxylic acid salts, salts of boric acid and the like.

4. A biodegradable sanitizing portable toilet solution composition as in claim 1, wherein said salt and said freeze-point depressant are combined wherein said salt comprises 50 percent to 84 percent and said freeze-point depressant comprises 16 to 50 percent of said portable toilet solution.

5. A biodegradable sanitizing portable toilet solution composition as in claim 1, wherein said portable toilet solution diluted comprises greater than 5 parts per million (ppm) chlorine concentration.

6. A biodegradable sanitizing portable toilet solution composition as in claim 1, wherein said fragrance is olfactory pleasing.

7. A biodegradable sanitizing portable toilet solution composition as in claim 1, wherein said colorant is a dark hue color.

8. A biodegradable sanitizing portable toilet solution composition as in claim 1, wherein said solution may be used for portable toilets in recreational vehicles, aircraft, buses, cruise ships and other forms of mass transmit and the like.

9. A method for a biodegradable sanitizing portable toilet solution composition comprising; providing a freezing-point depressant, a salt, a fragrance, and a colorant and optionally an insect repellant.

10. A method for providing biodegradable sanitizing portable toilet solution composition as in claim 8, wherein said freezing-point depressant comprises steepwater, distillers condensed solubles (DCS), condensed corn steep liquors (CCSL), sugar water solution, corn syrup, dissolved sugar solid, whey, monosaccharide, beet molasses, maltotriose, molasses, dextrose, sugar in the molecular range of 180 to 1638, polymers of dextrose, glycerols, glycols, carbohydrate, glucose, citric acid, fructose, lactic acid, hydroxycarboxylic acids, primary alcohols, hydroxycarboxylic acid esters, secondary alcohols, glycosides, tertiary alcohols, hydrocarbyl aldoside, glycolethers, amino acids, wheat, rice, lignin compounds, propylene glycol, soy, maltosides, brewers condensed solubles (BCS), glucopyranosides, vinters condensed solubles (VCS), decasaccharides, corn liquor, maltodextrins, malt swill, acetates, boric acid, sugar beet molasses, ethylene glycol, corn sugar molasses, furanosides, maltotriosides, sorbitol disaccharides, polysaccharides, maltitol, oligopeptide, citrus molasses, low molecular weight carbohydrate in the molecular weight range of about 180 to 1500, molecular weight of molasses in the range of 260 to 295 from cane sugar molasses or like by-products of agricultural processes.

11. A method for providing a biodegradable sanitizing portable toilet solution composition as in claim 8, wherein said salt comprises magnesium chloride (MgCl₂), sodium chloride (NaCl), calcium chloride (CaCl₂), brine, potassium chloride (KCl), sodium acetate, calcium magnesium acetate (CMA), potassium acetate, acetate salts, citrate salts, formate salts, salts of amino acids, dicarboxylic acid salts, salts of boric acid and the like.

12. A method for providing a biodegradable sanitizing portable toilet solution composition as in claim 8, wherein mixing of said salt and said freeze-point depressant are combined and wherein said salt comprises 50 percent to 84 percent and said freeze-point depressant comprises 16 to 50 percent of said portable toilet solution.

13. A method for providing a biodegradable sanitizing portable toilet solution composition as in claim 8, wherein diluting said portable toilet solution results in greater than a 5 parts per million (ppm) chlorine concentration in said composition.

14. A method for providing biodegradable sanitizing portable toilet solution composition as in claim 8, wherein adding said fragrance is olfactory pleasing.

15. A method for providing a biodegradable sanitizing portable toilet solution composition as in claim 8, wherein adding a colorant includes adding a dark hue colorant.

16. A method for providing a biodegradable sanitizing portable toilet solution composition as in claim 9, wherein said solution may be used for portable toilets in recreational vehicles, aircraft, buses, cruise ships and other forms of mass transmit and the like.

17. A system for sanitizing a portable toilet with a solution composition comprising; a freezing-point depressant, a salt, a fragrance, a colorant, and optionally an insect repellant wherein said solution composition is used in a portable toilet.

18. A system for sanitizing a portable toilet solution composition as in claim 15, wherein said freeze-point depressant comprises steepwater, distillers condensed solubles (DCS), condensed corn steep liquors (CCSL), sugar water solution, corn syrup, dissolved sugar solid, whey, monosaccharide, beet molasses, maltotriose, molasses, dextrose, sugar in the molecular range of 180 to 1638, polymers of dextrose, glycerols, glycols, carbohydrate, glucose, citric acid, fructose, lactic acid, hydroxycarboxylic acids, primary alcohols, hydroxycarboxylic acid esters, secondary alcohols, glycosides, tertiary alcohols, hydrocarbyl aldoside, glycolethers, amino acids, wheat, rice, lignin compounds, propylene glycol, soy, maltosides, brewers condensed solubles (BCS), glucopyranosides, vinters condensed solubles (VCS), decasaccharides, corn liquor, maltodextrins, malt swill, acetates, boric acid, sugar beet molasses, ethylene glycol, corn sugar molasses, furanosides, maltotriosides, sorbitol disaccharides, polysaccharides, maltitol, oligopeptide, citrus molasses, low molecular weight carbohydrate in the molecular weight range of about 180 to 1500, molecular weight of molasses from 260 to 295 from cane sugar molasses or like by-products of agricultural processes.

19. A system for sanitizing a portable toilet solution composition as in claim 15, wherein said salt comprises magnesium chloride (MgCl₂), sodium chloride (NaCl), calcium chloride (CaCl₂), brine, potassium chloride (KCl), sodium acetate, calcium magnesium acetate (CMA), potassium acetate, acetate salts, citrate salts, formate salts, salts of amino acids, dicarboxylic acid salts, salts of boric acid and the like.

20. A system for sanitizing a portable toilet solution composition as in claim 15, wherein said salt and said freeze-point depressant are combined wherein said salt comprises 50 percent to 84 percent and said freeze-point depressant comprises 16 to 50 percent of said portable toilet solution.

21. A system for sanitizing a portable toilet solution composition as in claim 15, wherein said portable toilet solution comprises greater than 5 parts per million (ppm) chlorine concentration.

22. A system for sanitizing a portable toilet solution composition as in claim 15, wherein said fragrance is olfactory pleasing.

23. A system for sanitizing a portable toilet with a solution composition as in claim 15, wherein said colorant is a dark hue color.

24. A system for providing a biodegradable sanitizing portable toilet solution composition as in claim 17, wherein said solution may be used for portable toilets in recreational vehicles, aircraft, buses, cruise ships and other forms of mass transmit and the like.
